(19) United States
(12) Patent Application Publication
(10) Pub. No.: US 2013/0227673 A1
(43) Pub. Date: Aug. 29, 2013

(54) APPARATUS AND METHOD FOR CLOUD NETWORKING

(71) Applicant: Electronics and Telecommunications Research In, (US)

(72) Inventor: Seung Hyun YOON, Daejeon (KR)

(73) Assignee: Electronics and Telecommunications Research Institute, Daejeon (KR)

(21) Appl. No.: 13/655,867

(22) Filed: Oct. 19, 2012

(30) Foreign Application Priority Data
Feb. 27, 2012 (KR) 1020120019891

(51) Int. Cl. G06F 21/00

(52) U.S. Cl. 726/15

(57) ABSTRACT

When a communication node receives a packet from a user terminal, the communication node inquires into a dynamic path mapping table and requests user authentication of the user terminal from a cloud networking control apparatus, if a VSI corresponding to information of the packet does not exist. If a user is an authenticated user, the cloud networking control apparatus performs provisioning of the VSI and transmits information of a VSI in which provisioning is performed to the communication node. After the VSI is set, the communication node connects the VSI to a virtual private network and transfers the packet to the VSI that is connected to the virtual private network.

### CROSS-REFERENCE TO RELATED APPLICATION

This application claims priority to and the benefit of Korean Patent Application No. 10-2012-0019891 filed in the Korean Intellectual Property Office on Feb. 27, 2012, the entire contents of which are incorporated herein by reference.

### BACKGROUND OF THE INVENTION

(a) Field of the Invention

The present invention relates to a method and apparatus for cloud networking. More particularly, the present invention relates to a method and apparatus for cloud networking for connecting a network between a user terminal and a cloud center using communication equipment.

(b) Description of the Related Art

Cloud computing is a computer environment in which information is permanently stored at a cloud center on the Internet and in which the information is temporarily stored at a user terminal, and can store information of a user at the cloud center and the information can be used anywhere and any place using various user terminals.

Currently, in a cloud computing environment, a user terminal and a cloud center are connected through the Internet. Therefore, a quality problem, a security problem, and a reliability problem variously occur. In order to solve a security problem, IP tunneling technology such as Internet Protocol Security (IPSec) is applied, but quality and reliability is at the level of the Internet.

In order to solve a quality problem, a security problem, and a reliability problem, in a corporation, an exclusive line may be separately installed or a virtual private network may be used between a corporation and a data center, but because these methods are statistically controlled, these methods are limitedly applied at a specific position, and thus it is difficult to apply these methods to users needing mobility. Particularly, as smart work and remote work are activated, a quality problem, a security problem, and a reliability problem further increase. Therefore, for a connection between a user and a cloud center, technology that can provide a networking function of a virtual private network to a moving user is requested.

### SUMMARY OF THE INVENTION

The present invention has been made in an effort to provide a method and apparatus for cloud networking having advantages of directly connecting a moving user and a cloud center through a virtual private network.

An exemplary embodiment of the present invention provides a method of cloud networking that connects a user terminal to a cloud center through a virtual private network in a communication node. The method includes: receiving a packet from the user terminal; determining whether a user of the user terminal is an authenticated user, when a virtual switch instance (VSI) corresponding to information of the packet does not exist at a dynamic path mapping table; receiving, if the user of the user terminal is an authenticated user, information of the VSI from a cloud networking control apparatus; connecting the VSI using the information of the VSI to the virtual private network; and transferring the packet to the VSI that is connected to the virtual private network.

The transferring of the packet may include mapping the VSI to the information of the packet and storing the VSI at the dynamic path mapping table.

The method may further include transferring, when a VSI corresponding to information of the packet exists at the dynamic path mapping table, the packet to the VSI.

The determining of whether a user of the user terminal is an authenticated user may include requesting the user's authentication to the cloud networking control apparatus, and receiving the user's authentication result from the cloud networking control apparatus.

Another embodiment of the present invention provides a method of cloud networking that connects a user terminal to a cloud center through a virtual private network in a cloud networking control apparatus. The method includes: receiving, when a VSI corresponding to information of the packet does not exist at a dynamic path mapping table, an authentication request for a user of the user terminal from a communication node; authenticating the user; performing provisioning of the VSI to the communication node if the user is an authenticated user; and performing provisioning of a path to the communication node in order for the communication node to connect the VSI to the virtual private network.

The method may further include transmitting information of the VSI to the communication node.

Yet another embodiment of the present invention provides a cloud networking apparatus that connects a user terminal to a cloud center through a virtual private network. The cloud networking apparatus includes: a path inquiry unit that inquires whether a VSI corresponding to information of a packet exists at a dynamic path mapping table, when a packet is received from the user terminal, and that transfers the packet to the VSI corresponding to the information of the packet; an authentication unit that requests authentication of the user to the cloud networking apparatus, if a VSI corresponding to information of the packet does not exist at a dynamic path mapping table; a VSI setting unit that receives the information of the VSI of the authenticated user from the cloud networking control apparatus and that sets the VSI and connects the VSI to the network; and a path mapping unit that maps the set VSI to the information of the packet and that stores the VSI at the dynamic path mapping table.

The VSI setting unit may connect the set VSI to a VSI that is set to another communication node of the network through a tunnel.

### BRIEF DESCRIPTION OF THE DRAWINGS

FIG. 1 is a diagram illustrating a method of cloud networking according to an exemplary embodiment of the present invention.

FIG. 2 is a diagram illustrating a cloud networking apparatus according to an exemplary embodiment of the present invention.

FIG. 3 is a block diagram illustrating a configuration of a communication node according to an exemplary embodiment of the present invention.

FIG. 4 is a block diagram illustrating a configuration of a cloud networking control apparatus according to an exemplary embodiment of the present invention.

FIG. 5 is a flowchart illustrating a method of cloud networking in a communication node according to an exemplary embodiment of the present invention.

FIG. 6 is a flowchart illustrating a method of cloud networking in a cloud networking control apparatus according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification and claims, unless explicitly described to the contrary, the word “comprise” and variations such as “comprises” or “comprising” will be understood to imply the inclusion of stated elements but not the exclusion of any other elements.

Hereinafter, a method and apparatus for cloud networking according to an exemplary embodiment of the present invention will be described in detail with reference to the drawings.

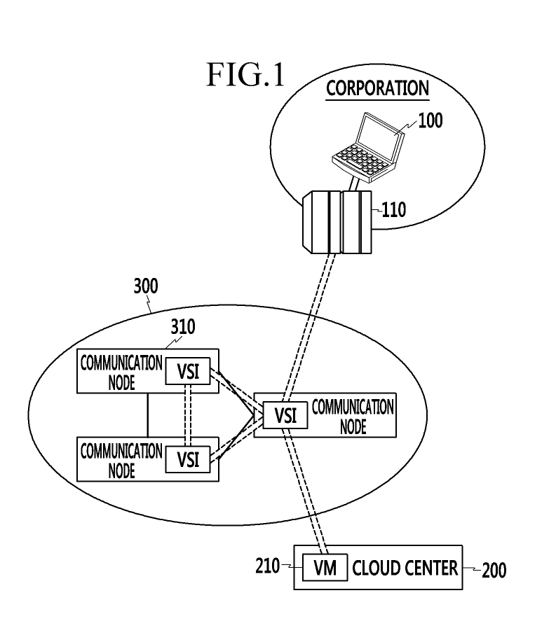

FIG. 1 is a diagram illustrating an example of a virtual private network according to an exemplary embodiment of the present invention.

Referring to FIG. 1, a virtual private network (VPN) 300 is generally used in a corporation. FIG. 1 illustrates a layer 2-based VPN as the VPN 300.

In general, the VPN 300 connects a virtual switch instance (VSI) that is set to each communication node 310 to an exclusive path, thereby providing an Ethernet-line (E-Line) service or an Ethernet-LAN (E-LAN) service. Here, the exclusive path may be a multi-protocol label switching transport profile (MPLS-TP), provider backbone bridge traffic engineering (PBB-TE), or a carrier Ethernet-based tunnel. In FIG. 1, a solid line that is connected between communication nodes 300 indicates a physical connection.

A user terminal 100 of a corporation is connected to a cloud center 200 through the VPN 300.

The cloud center 200 stores and manages data to provide it to the user terminal 100. The cloud center 200 includes a virtual machine 210, and the virtual machine 210 is connected to a VSI that is set to the communication node 310 through a tunnel and provides data to the user terminal 100 through the connected tunnel. In this case, in consideration of the user terminal 100 of a corporation at a remote location, because VSIs are previously set at all communication nodes 310 and cannot be connected, by installing a VPN gateway 110 of an IP overlay method at the inside of a corporation network, the user terminal 100 of a corporation at a remote location can be connected to the cloud center 200 via the VPN gateway 110. However, because a user should approach the VPN gateway 110 with an IP overlay method, such a method has a quality problem or a reliability problem.

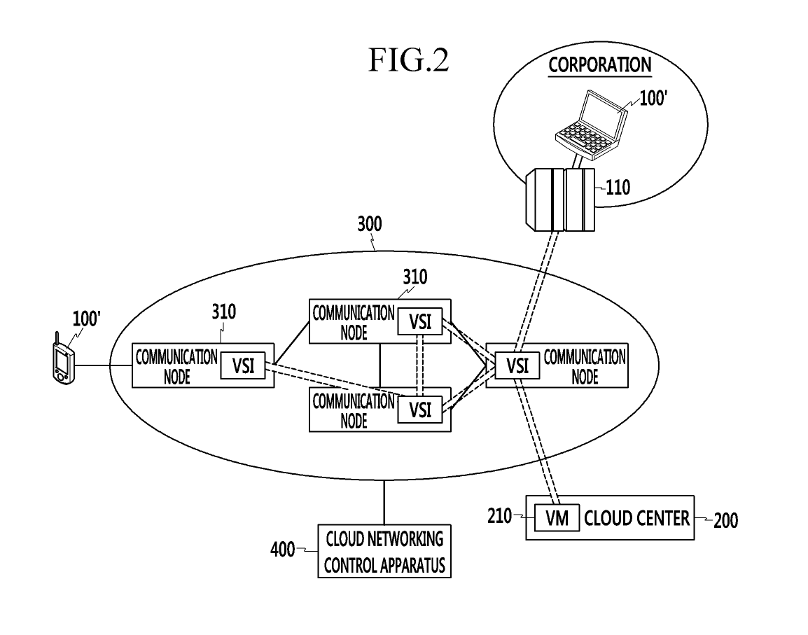

Hereinafter, a method of cloud networking of a moving user will be described in detail with reference to FIGS. 2 to 6.

FIG. 2 is a diagram illustrating a cloud networking apparatus according to an exemplary embodiment of the present invention.

Referring to FIG. 2, in the cloud networking apparatus, a user terminal 100′ of a moving user is directly connected to a cloud center 200 using a VPN 300.

The cloud networking apparatus includes a plurality of communication nodes 310 of the VPN 300 and a cloud networking control apparatus 400.

The communication node 310 is communication equipment such as a router or a packet transmission switch and is a VSI and equipment in which a tunnel can be set. The communication node 310 performs a function of transferring data between the user terminal 100′ and the cloud center 200. As the communication node 310, for example, a packet transport layer (PTL) node or an IP/MPLS node may be used. Hereinafter, for convenience of description, it is assumed that the communication node 310 is a PTL node.

In order to connect the user terminal 100′ and the cloud center 200, the communication node 310 performs user authentication of the user terminal 100′, sets a VSI according to the control of the cloud networking control apparatus 400, and connects the set VSI to a VSI of another communication node through a tunnel. Next, the communication node 310 sets a dynamic path mapping table of a VSI that is set to a packet that receives from the user terminal 100′.

When the communication node 310 receives a packet from the authenticated user terminal 100′, the communication node 310 transfers the received packet to a corresponding VSI with reference to the dynamic path mapping table. Thereafter, the communication node 310 operates similarly to a conventional VPN function.

When the communication node 310 is an IP/MPLS router, the communication node 310 sets a virtual routing and forwarding instance (VRF) instead of a VSI, connects the VRF to a VRF of another communication node, and thus a layer 3 VPN or an IP VPN may be formed.

The cloud networking control apparatus 400 controls a connection between the user terminal 100′ and the cloud center 200. Particularly, the cloud networking control apparatus 400 performs a function of authenticating a user of the user terminal 100′, performs provisioning of a VSI to the communication node 310 for a connection between the user terminal 100′ and the cloud center 200, calculates a path for a connection of the VSI in which provisioning is performed in consideration of a network resource and a VSI that is set to each communication node 310 of the VPN 300, and performs provisioning of a path to the communication node 310 to be connected to a VSI of another communication node. Here, the VSI in which provisioning is performed is a VSI that is newly made to the communication node 310 through a setting command. Provisioning is to set a function or operation to the communication node 310. In short, a function can be enabled/disabled, and a detailed instruction that instructs to connect a path from which location to which location may be given, and in the cloud networking control apparatus 400, such setting that performs the communication node 310 is referred to as provisioning. Provisioning may be performed using a command line interface (CLI) or with a SNMP set command.

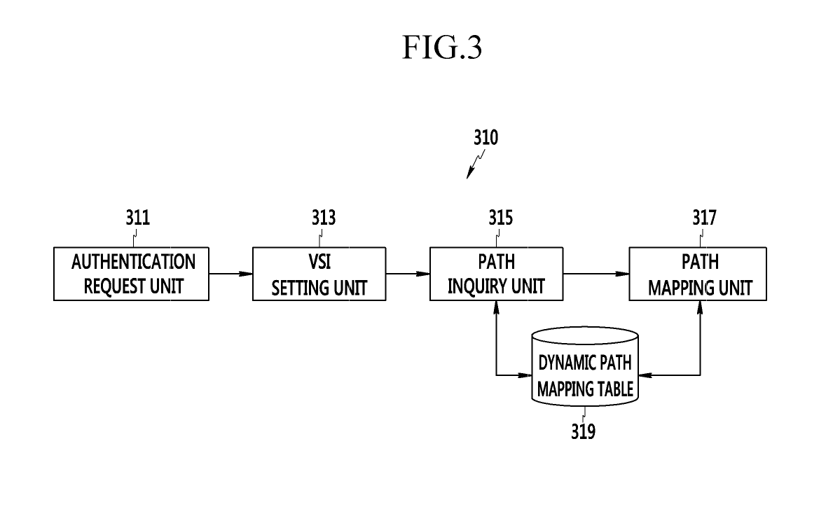

FIG. 3 is a block diagram illustrating a configuration of a communication node according to an exemplary embodiment of the present invention.

Referring to FIG. 3, the communication node 310 includes an authentication request unit 311, a VSI setting unit 313, a path inquiry unit 315, a path mapping unit 317, and a dynamic path mapping table 319.

The authentication request unit 311 receives an authentication request of the path inquiry unit 315, requests user authentication of the user terminal 100′ of the cloud networking control apparatus 400, and receives an authentication result from the cloud networking control apparatus 400.

The VSI setting unit 313 sets a VSI according to the control of the cloud networking control apparatus 400 and connects the set VSI to a VSI that is set to another communication apparatus of the VPN 300.

When the path inquiry unit 315 receives a packet from the user terminal 100′, the path inquiry unit 315 inquires into a path of the received packet with reference to the dynamic path mapping table 319 and transfers the received packet to a corresponding VSI. When a path of the received packet does not exist at the dynamic path mapping table 319, the path mapping unit 317 requests user authentication from the authentication request unit 311 and connects the user terminal 100′ to the VPN 300.

The path mapping unit 317 maps and stores a VSI to correspond to information of a packet that it receives from the authenticated user terminal 100′ according to the control of the cloud networking control apparatus 400. That is, the path mapping unit 317 manages a dynamic path mapping table 319.

At the dynamic path mapping table 319, a VSI is stored to correspond to at least one of information of a packet that it receives from the authenticated user terminal 100′.

At the dynamic path mapping table 319, for example, a VLAN identifier (ID) or a receiving port of the communication node 310 in which a packet of the authenticated user terminal 100′ is received may be mapped to the VSI, and information (IP address, application port address, etc.) that is included in a header of the packet may be mapped to the VSI.

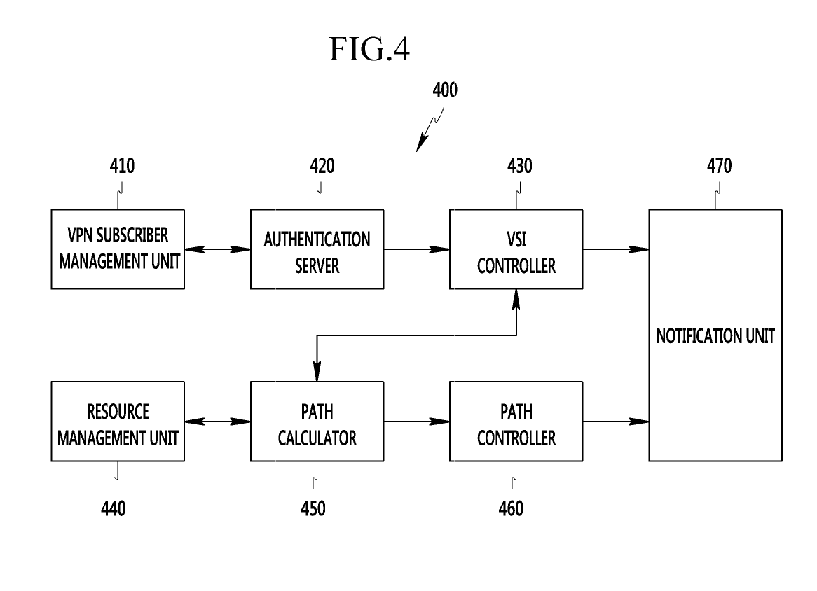

FIG. 4 is a block diagram illustrating a configuration of a cloud networking control apparatus according to an exemplary embodiment of the present invention.

Referring to FIG. 4, the cloud networking control apparatus 400 includes a VPN subscriber management unit 410, an authentication server 420, a VSI controller 430, a resource management unit 440, a path calculator 450, and a path controller 460.

The VPN subscriber management unit 410 manages a VPN subscriber's information. The VPN subscriber management unit 410 stores and manages information that is related to the VPN subscriber. For example, the VPN subscriber management unit 410 stores and manages a name, a social security number, a phone number, a job, an address, etc. as basic information.

When the authentication server 420 receives a request for user authentication from the communication node 310, the authentication server 420 authenticates a corresponding user. The authentication server 420 inquiries into the VPN subscriber management unit 410 regarding whether a user is a VPN subscriber and authenticates the user terminal 100′.

When the user is successfully authenticated by the authentication server 420, the VSI controller 430 performs provisioning of the VSI to the communication node 310.

The resource management unit 440 manages a network resource of the VPN 300. That is, the resource management unit 440 manages topology, resource allocation, and a network connection state of the VPN 300.

The path calculator 450 calculates a path for connecting a VSI in which provisioning is performed to a VSI of another communication node in consideration of a VSI that is set to each communication node 310 of the VPN 300, and a network resource and a path between the VSIs. The path calculator 450 calculates an optimum path for connecting the VSI in which provisioning is performed according to various conditions to a VSI of another communication node.

The path controller 460 performs provisioning of a path that is calculated to connect the VSI in which provisioning is performed to a VSI of another communication node to the communication node 310.

A notification unit 470 transmits a user authentication result in which a request for authentication is received from the communication node 310 to the authentication request unit 311 of the communication node 310. The notification unit 470 notifies the communication node 310 of information of a VSI in which provisioning is performed while transmitting a user authentication success message to the communication node 310. Information of the VSI in which provisioning is performed may include ID or a name of a VSI that can identify the information in the communication node 310.

Therefore, the communication node 310 stores a VSI at the dynamic path mapping table 319 based on information of the VSI that it receives from the cloud networking control apparatus 400.

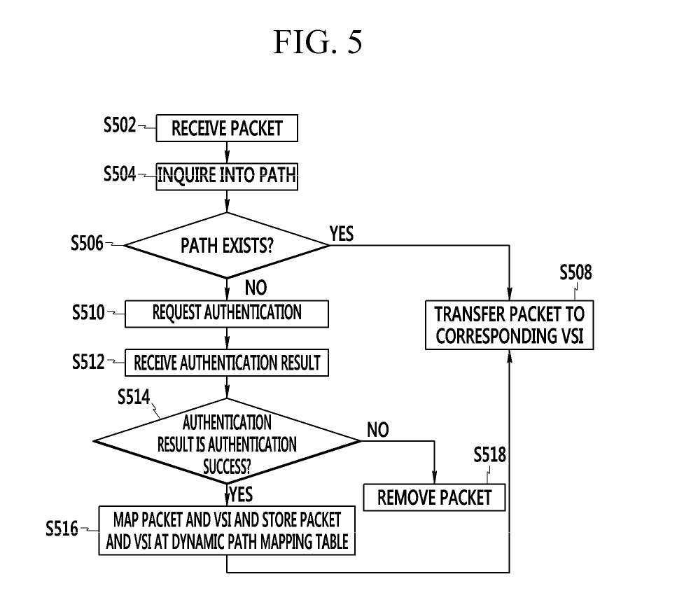

FIG. 5 is a flowchart illustrating a method of cloud networking in a communication node according to an exemplary embodiment of the present invention.

Referring to FIG. 5, when the communication node 310 receives a packet from the user terminal 100′ (S502), the communication node 310 inquires into a path of the received packet with reference to the dynamic path mapping table 319 (S504).

The communication node 310 determines whether the path of the received packet exists at the dynamic path mapping table 319 (S506), and if the path of the received packet exists at the dynamic path mapping table 319, the communication node 310 transfers the received packet to a corresponding VSI (S508).

If the path of the received packet does not exist at the dynamic path mapping table 319, the communication node 310 requests user authentication of the user terminal 100′ from the cloud networking control apparatus 400 (S510).

The communication node 310 receives an authentication result from the cloud networking control apparatus 400 (S512), and the communication node 310 determines whether an authentication result is authentication success (S514), and if the authentication result is authentication success, the communication node 310 maps a packet that it receives from the user terminal 100′ and a corresponding VSI based on information of the received VSI, stores the packet and the VSI at the dynamic path mapping table 319 (S516), and transfers the packet that it receives from the user terminal 100′ to the corresponding VSI (S508).

If an authentication result is an authentication failure, the communication node 310 removes the packet that it receives from the user terminal 100′ (S518).

In this way, the communication node 310 sets a VSI of a user of the user terminal 100′ of which authentication has succeeded, and dynamically connects the VSI to a VSI of a preset another communication node, and thus even if the user moves, the communication node 310 can directly connect the user terminal 100′ to the VPN 300.

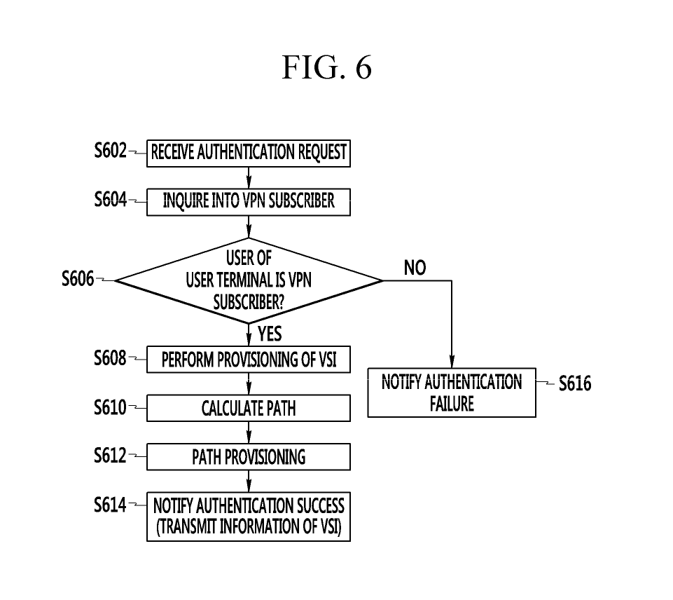

FIG. 6 is a flowchart illustrating a method of cloud networking in a cloud networking control apparatus according to an exemplary embodiment of the present invention.

Referring to FIG. 6, when the cloud networking control apparatus 400 receives an authentication request of a user of the user terminal 100′ from the communication node 310 (S602), the cloud networking control apparatus 400 inquires into a VPN subscriber (S604).

The cloud networking control apparatus 400 determines whether the user of the user terminal 100′ is a VPN subscriber (S606), and if the user of the user terminal 100′ is a VPN subscriber, the cloud networking control apparatus 400 performs provisioning of the VSI to the communication node 310 (S608).

The cloud networking control apparatus 400 calculates an optimum path for connection of the VSI in which provisioning is performed in consideration of the VSI that is set to the VPN 300, a path, and a network resource (S610).

The cloud networking control apparatus 400 performs provisioning of the calculated optimum path to the communication node 310 (S612), and connects the VSI to a VSI of another communication node at the communication node 310.

Next, the cloud networking control apparatus 400 notifies the communication node 310 of authentication success of the user of the user terminal 100′ (S614). In this case, the cloud networking control apparatus 400 transmits information of the VSI in which provisioning is performed to the communication node 310.

If the user of the user terminal 100′ is not a VPN subscriber at step S606, the cloud networking control apparatus 400 notifies the communication node 310 of an authentication failure (S616).

The foregoing apparatus and/or method has been described using an L2-based VPN 300, but the apparatus and/or method can be applied even to a SONET/SDH network to which a router-based L3 VPN, an IP-based VPN, and a carrier Ethernet-based VPN, or a multi-service provisioning platform (MSPP), are coupled.

According to an exemplary embodiment of the present invention, a layer 2 VPN having higher quality, security, and stability than that of an existing Internet network can be provided to a moving user. Accordingly, a high quality cloud service environment and remote work environment can be provided, and exclusive networking of a user group or a service unit can be provided.

An exemplary embodiment of the present invention may not only be embodied through the above-described apparatus and/or method, but may also embodied through a program that executes a function corresponding to a configuration of the exemplary embodiment of the present invention or through a recording medium on which the program is recorded, and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of cloud networking that connects a user terminal to a cloud center through a virtual private network in a communication node, the method comprising:
receiving a packet from the user terminal;
determining whether a user of the user terminal is an authenticated user, when a virtual switch instance (VSI) corresponding to information of the packet does not exist at a dynamic path mapping table;
receiving, if the user of the user terminal is an authenticated user, information of the VSI from a cloud networking control apparatus;
connecting the VSI using the information of the VSI to the virtual private network; and
transferring the packet to the VSI that is connected to the virtual private network.

2. The method of claim 1, wherein the transferring of the packet comprises mapping the VSI to the information of the packet and storing the VSI at the dynamic path mapping table.

3. The method of claim 2, further comprising transferring, when a VSI corresponding to information of the packet exists at the dynamic path mapping table, the packet to the VSI.

4. The method of claim 1, wherein the determining of whether a user of the user terminal is an authenticated user comprises:
requesting the user's authentication to the cloud networking control apparatus; and
receiving the user's authentication result from the cloud networking control apparatus.

5. The method of claim 1, wherein the connecting of the VSI comprises connecting the VSI to a VSI that is set to another communication node of the virtual private network.

6. The method of claim 1, further comprising removing, if a user of the user terminal is not an authenticated user, the packet.

7. The method of claim 1, wherein the communication node comprises a router or a packet transmission switch.

8. A method of cloud networking that connects a user terminal to a cloud center through a virtual private network in a cloud networking control apparatus, the method comprising:
receiving, when a VSI corresponding to information of the packet does not exist at a dynamic path mapping table, an authentication request for a user of the user terminal from a communication node;
authenticating the user;
performing provisioning of a VSI to the communication node if the user is an authenticated user; and
performing provisioning of a path to the communication node in order for the communication node to connect the VSI to the virtual private network.

9. The method of claim 8, wherein the performing of provisioning of a path comprises calculating the path in consideration of a network resource and at least one VSI existing at the virtual private network.

10. The method of claim 8, further comprising transmitting information of the VSI to the communication node.

11. A cloud networking apparatus that connects a user terminal to a cloud center through a virtual private network, the cloud networking apparatus comprising:
a path inquiry unit that inquires whether a VSI corresponding to information of a packet exists at a dynamic path mapping table, when a packet is received from the user terminal, and that transfers the packet to the VSI corresponding to information of the packet;
an authentication unit that requests authentication of the user to the cloud networking apparatus, if a VSI corresponding to information of the packet does not exist at a dynamic path mapping table;
a VSI setting unit that receives the information of the VSI of the authenticated user from the cloud networking control apparatus and that sets the VSI and connects the VSI to the virtual private network; and
a path mapping unit that maps the set VSI to the information of the packet and that stores the VSI at the dynamic path mapping table.

12. The cloud networking apparatus of claim 11, wherein the VSI setting unit connects the set VSI to a VSI that is set to another communication node of the virtual private network through a tunnel.

13. The cloud networking apparatus of claim 11, wherein the cloud networking apparatus comprises a router or a packet transmission switch.
